(19) United States
(12) Patent Application Publication
(10) Pub. No.: US 2013/0268376 A1
(43) Pub. Date: Oct. 10, 2013

(54) SERVICE-BASED DEMONSTRATION EXPERIENCE CONFIGURATION

(71) Applicants: Daniel Vargas Gonzalez, Seattle, WA (US); Scott D. Neilson, Kirkland, WA (US); John B. Eversole, Seattle, WA (US); Christian P. Johanneson, Monroe, WA (US)

(72) Inventors: Daniel Vargas Gonzalez, Seattle, WA (US); Scott D. Neilson, Kirkland, WA (US); John B. Eversole, Seattle, WA (US); Christian P. Johanneson, Monroe, WA (US)

(73) Assignee: MICROSOFT CORPORATION, Redmond, WA (US)

(21) Appl. No.: 13/441,156

(22) Filed: Apr. 6, 2012

(51) Int. Cl. G06Q 30/02

(52) U.S. Cl. 705/14.72

(57) ABSTRACT

A demonstration service receives content from various content providers, and maintains the received content. The content can be provided to the demonstration service at various times, and changed as desired by the content providers. A retailer can access the demonstration service and select various content to include in demonstration experiences for various groups of demonstration devices in a retailer environment. The demonstration experiences can be changed at various times as desired by the retailer. Demonstration experience descriptions and/or changes to demonstration experience descriptions are provided to the demonstration devices, allowing each demonstration device to present a demonstration experience as defined by the retailer.

### BACKGROUND

As technology has advanced, many different types of devices have become available to users, such as computers, smart phones, digital cameras, and so forth. Retailers oftentimes have many different types of devices available as demonstration devices, presenting demonstration experiences allowing users to interact and “play” with the devices to determine whether the devices are a good fit for the users. The demonstration experiences typically display demonstration videos or other content, and/or allow users to use particular functionality of the devices. However, these demonstration experiences are not without their problems. One such problem is that retailers typically receive updates to these demonstration experiences only a few times per year, which can be restrictive and frustrating for retailers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, content from one or more content providers is maintained at a service. A retailer request to configure a demonstration experience for one or more devices in a retailer environment is received at a service, and the retailer request identifies content to include in the demonstration experience. A demonstration experience description identifying the content to include in the demonstration experience is maintained at the service and provided to the one or more devices in the retailer environment.

In accordance with one or more aspects, content from one or more content providers is maintained at a service. A retailer request indicating content to be included in a demonstration experience for one or more devices in a retailer environment is received via an interface exposed at the service. A demonstration experience description identifying the indicated content is provided from the service to the one or more devices.

### BRIEF DESCRIPTION OF THE DRAWINGS

The same numbers are used throughout the drawings to reference like features.

FIG. 1 illustrates an example system implementing the service-based demonstration experience configuration in accordance with one or more embodiments.

FIG. 2 illustrates an example demonstration service and devices in accordance with one or more embodiments.

FIG. 3 illustrates an example retailer environment in accordance with one or more embodiments.

FIG. 4 is a flowchart illustrating an example process for implementing service-based demonstration experience configuration in accordance with one or more embodiments.

FIG. 5 is a flowchart illustrating an example process for implementing bandwidth-aware obtaining of demonstration experience content in accordance with one or more embodiments.

FIG. 6 illustrates an example computing device that can be configured to implement the service-based demonstration experience configuration in accordance with one or more embodiments.

### DETAILED DESCRIPTION

Service-based demonstration experience configuration is discussed herein. A demonstration service receives content from various content providers and maintains the received content. The content can be provided to the demonstration service at various times, and changed as desired by the content providers. A retailer can access the demonstration service and select various content to include in demonstration experiences for various groups of demonstration devices in a retailer environment. The demonstration experiences can be changed at various times as desired by the retailer. Demonstration experience descriptions and/or changes to demonstration experience descriptions are provided to the demonstration devices, allowing each demonstration device to present a demonstration experience as defined by the retailer.

In some situations, a demonstration device does not have particular content to be presented as part of the demonstration experience, and thus the demonstration device obtains that particular content. If another demonstration device in the same retailer environment has the content, then the demonstration device obtains the content from that other demonstration device in the same retailer environment. However, if no other demonstration device in the same retailer environment has the content, then the demonstration device obtains the content from the demonstration service.

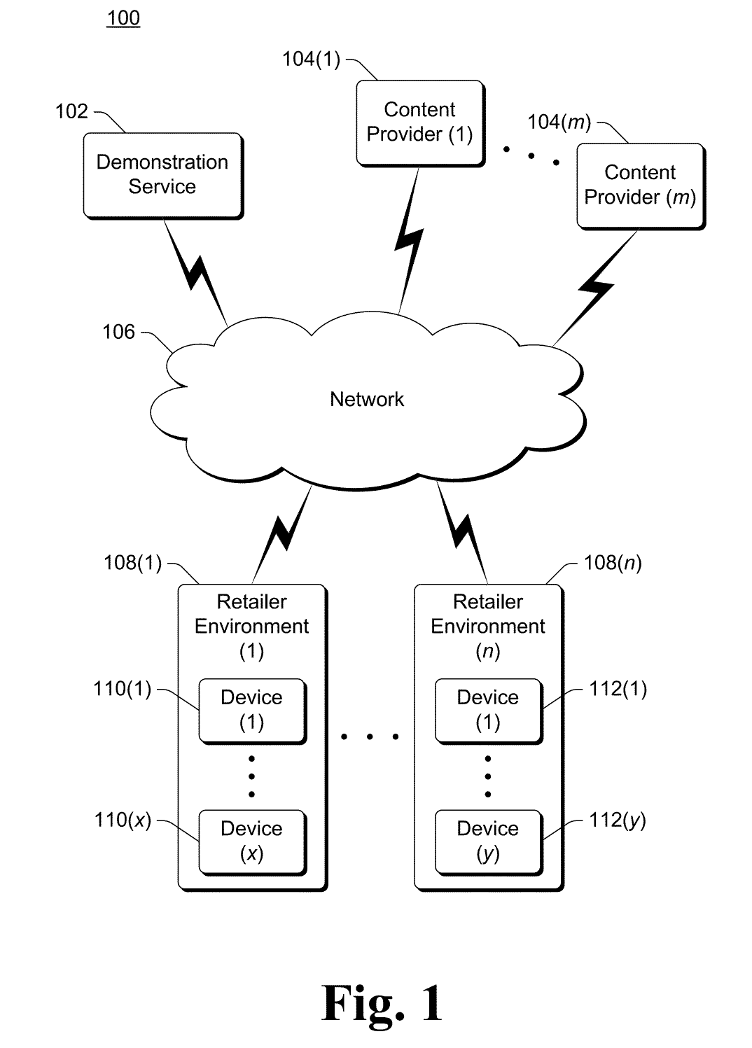

FIG. 1 illustrates an example system 100 implementing the service-based demonstration experience configuration in accordance with one or more embodiments. System 100 includes a demonstration service 102, and one or more (m) content providers 104(1), . . . , 104(m) that can communicate with demonstration service 102 via a network 106. System 100 also includes multiple retailer environments 108(1), . . . , 108(n), each including one or more devices 110, 112 that can communicate with demonstration service 102 via network 106. Network 106 can be a variety of different networks, including the Internet, a local area network (LAN), a public telephone network, an intranet, other public and/or proprietary networks, combinations thereof, and so forth.

Each computing device 110, 112 can be a variety of different types of devices. For example, each computing device 110, 112 can be a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth. Thus, devices 110, 112 may range from full resource devices with substantial memory and processor resources (e.g., personal computers, game consoles) to low-resource devices with limited memory and/or processing resources (e.g., traditional set-top boxes, televisions). Different computing devices 110, 112 can be the same types of devices and/or different types of devices.

Each retailer environment 108 includes one or more (e.g., illustrated as x or y) devices 110, 112. Different retailer environments 108 can have the same number of devices 110, 112 and/or different numbers of devices 110, 112. A retailer environment 108 refers to an environment in which a retailer (oftentimes a business) displays and typically sells devices. The retailer that is displaying and/or selling devices in retailer environment 108 is also referred to as being associated with or corresponding to retailer environment 108. As used herein, references to the retailer also refer to a representative or agent of the retailer (e.g., an administrator or other authorized user of the retailer). Thus, the retailer taking actions (such as providing inputs or requests) also refers to an action taken by a representative or agent of the retailer. The retailer can display and/or sell any of a variety of different types of devices, such as any of the types of devices discussed above with reference to devices 110, 112. A retailer environment 108 can be a single location, such as a single building or a single room (e.g., a single showroom floor). Alternatively, a retailer environment 108 can be spread across multiple locations, such as multiple different buildings (optionally spread across multiple geographic areas, such as different parts of the same city, different cities, and so forth).

Devices 110, 112 of a particular retailer environment 108 can communicate with demonstration service 102 to obtain demonstration experience descriptions and/or content, as discussed in more detail below. Demonstration experience descriptions (also referred to herein as simply descriptions) identify the content that is to be displayed or otherwise presented by devices 110, 112 as a demonstration experience. The demonstration experience descriptions can also identify how the content is to be displayed or otherwise presented by devices 110, 112. The demonstration experience for a device refers to the demonstration displayed or otherwise presented on the device, including video and/or audio played back, images displayed, programs that can be run by a user of the device, links to programs that can be selected by the user of the device, and so forth.

The demonstration experience description for a particular device 110, 112 can be specified by a retailer, as discussed in more detail below. Additionally, devices 110, 112 of a particular retailer environment 108 can communicate with one another via a retailer environment network, allowing content to be communicated among devices 110, 112 of that particular retailer environment 108, as discussed in more detail below.

Demonstration service 102 maintains demonstration experience descriptions and optionally at least some content for devices 110, 112. Demonstration service 102 is external to the retailer environment 108, which refers to demonstration service 102 not being included as part of the retailer environment 108. Content can be provided to demonstration service 102 by one or more (m) content providers 104. Content providers 104 can be various entities or parties, such as software and/or hardware original equipment manufacturers (OEMs), software and/or hardware developers, software and/or hardware distributors or resellers, and so forth. For example, content providers 104 can be companies that manufacture and/or distribute particular brands of devices, companies that manufacture and/or distribute particular brands of programs for devices, and so forth. Demonstration service 102 can be implemented using one or more of a variety of different types of devices (the same and/or different types of devices), such as any of the types of devices discussed above with reference to devices 110, 112. Content providers 104 can also be implemented using one or more of a variety of different types of devices (the same and/or different types of devices), such as any of the types of devices discussed above with reference to devices 110, 112.

Generally, in system 100, content providers 104 provide content to demonstration service 102. The content provided to demonstration service 102 can be, for example, data to be presented (e.g., video or images to be played back) or an identifier of where data can be obtained (e.g., a path or link to data on a particular one or more devices 110, 112). A retailer accesses demonstration service 102 to create a demonstration experience description for a particular one or more devices 110, 112. The demonstration experience description includes content, identifiers of content, and/or identifiers of where to obtain content for the demonstration experiences on devices 110, 112. The retailer can create different demonstration experience descriptions for different devices 110, 112 based on various criteria, such as different demonstration experience descriptions for each different device at the retailer environment of that retailer, different demonstration experience descriptions for different brands of devices or expected uses of devices (e.g., gaming devices, business devices, etc.) at the retailer environment of that retailer, and so forth.

Each device 110, 112 obtains demonstration experience descriptions for the device from demonstration service 102. Each device 110, 112 also obtains content, if not already included on the device, to be presented as part of the demonstration experience on the device. To obtain desired content, a device queries other devices in the same retailer environment for the content. If another device in the same retailer environment has the desired content, then the device obtains the desired content from that other device. However, if no other device in the same retailer environment has the desired content, then the device obtains the desired content from demonstration service 102.

Devices discussed herein, such as devices 110, 112, devices implementing demonstration service 102, devices implementing content providers 104, other devices, and so forth can receive inputs from a user of the device. User inputs can be provided in a variety of different manners, such as by pressing one or more keys of a keypad or keyboard of the device, pressing one or more keys of a controller (e.g., remote control device, mouse, track pad, etc.) of the device, pressing a particular portion of a touchpad or touchscreen of the device, moving a finger or other object within a particular distance of a pad or screen of the device, making a particular gesture on a touchpad or touchscreen of the device, and/or making a particular gesture on a controller (e.g., remote control device, mouse, track pad, etc.) of the device. User inputs can also be provided via other physical feedback input to the device, such as tapping any portion of the device, an action that can be recognized by a motion detection component of the device (such as shaking the device, rotating the device, etc.), and so forth. User inputs can also be provided in other manners, such as via audible or voice inputs to a microphone, via motions of hands or other body parts observed by an image capture device, and so forth.

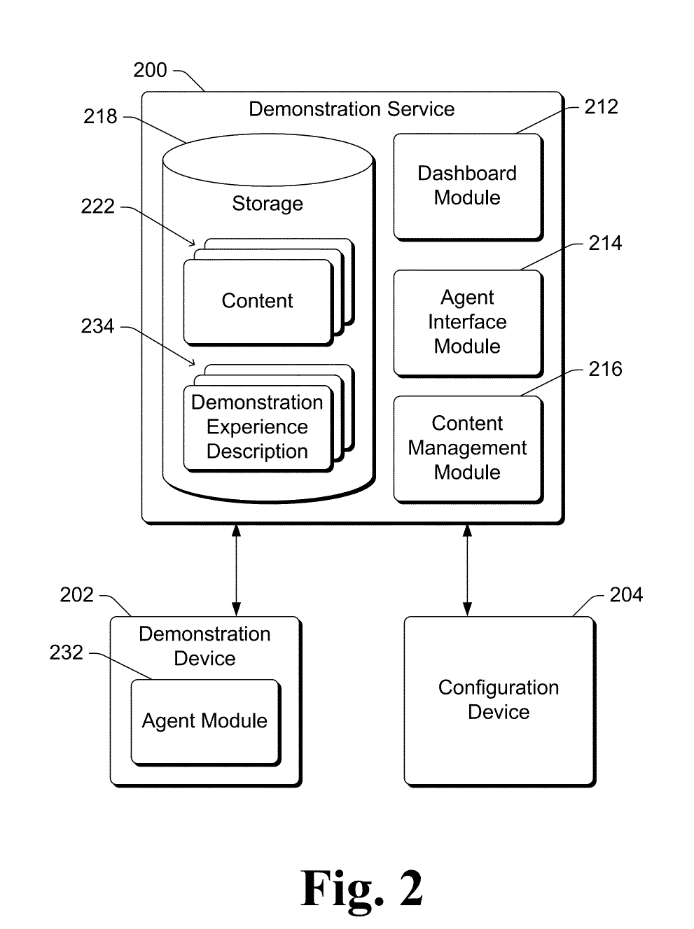

FIG. 2 illustrates an example demonstration service 200 and devices 202, 204 in accordance with one or more embodiments. Demonstration service 200 is, for example, a demonstration service 102 of FIG. 1. Demonstration device 202 is, for example, a device 110 or 112 of FIG. 1 that displays or otherwise presents content. Configuration device 204 is a device used by a retailer to create a demonstration description, and can optionally be a device 110 or 112 of FIG. 1.

Demonstration service 200 includes a dashboard module 212, an agent interface module 214, a content management module 216, and storage component 218. Each module 212-216 can be implemented in software, firmware, hardware, or combinations thereof. Although specific modules are illustrated in FIG. 2, it should be noted that additional modules can be included in demonstration service 200. Additionally, it should be noted that the functionality of multiple modules illustrated in demonstration service 200 can be combined into a single module, and/or the functionality of one or more modules illustrated in demonstration service 200 can be separated into multiple modules.

Dashboard module 212 provides an interface allowing content to be received at demonstration service 200 from content providers. Dashboard module 212 also allows demonstration experience descriptions to be configured by retailers, as discussed in more detail below. Dashboard module 212 can receive content from content providers in a variety of different manners. In one or more embodiments, dashboard module 212 exposes a Web interface that allows the content provider (e.g., a user) to upload, create, or otherwise transfer content to demonstration service 200. In addition, or alternatively, the content provider (e.g., a user) can identify or create content on another device, which in turn sends or otherwise provides the identified or created content to dashboard module 212. Content providers can, via dashboard module 212, add content to and/or modify content at demonstration service 200 as they desire at virtually any time.

Content received from content providers is stored as content 222 in storage component 218. Storage component 218 can be one or more of any of a variety of storage devices. Storage component 218 is oftentimes one or more magnetic disks, although other types of storage devices can alternatively be used (e.g., optical disks, Flash memory, and so forth).

In one or more embodiments, content is stored as associated with the particular content provider that provided the content, allowing various security functionality based on the content provider to be supported by demonstration service 200. For example, service 200 can permit content to be deleted or edited only by the same content provider as provided the content to service 200. Content can be associated with a particular content provider in different manners, such as storage component 218 having different storage areas (e.g., folders, databases, files, etc.) for each content provider, storing content as a file or other record having an associated content provider identifier, and so forth.

Various different types of content can be received by demonstration service 200 from content providers. This content refers to data that can be displayed or otherwise presented by a device, information indicating how a device is to display or otherwise present data, programs that can be run by a device, identifiers of where such data, information, and/or programs are located, and so forth. The content received from content providers is provided for use in a demonstration experience by various demonstration devices, and the particular content used by a particular demonstration device is determined by the retailer, as discussed in more detail below.

Data that can be displayed or otherwise presented by a device includes text, images, video, audio, combinations thereof, and so forth. Information indicating how a device is to display or otherwise present data includes instructions, rules, parameters, and so forth describing how data is to be displayed or presented. For example, this information can indicate a font or color to use when displaying text, a volume to use when playing audio, a rate at which to display images in a slide show, and so forth. By way of another example, this information can include timing rules or parameters that indicate a timeframe for when (e.g., particular times of day, particular days of the week, particular date ranges, and so forth) data can be presented. The timeframe can be associated with particular data, so that the data is displayed or otherwise presented only when the timeframe indicates the data can be displayed or otherwise presented.

Programs that can be run by a device include various instructions, binaries or other executable files, scripts or other interpreted programs, and so forth. Identifiers of where data, information, and/or programs are located include uniform resource identifiers (URIs), path names, identifiers of file packages or containers, and so forth. It should be noted that these identifiers can be, and oftentimes are, identifiers of locations on the demonstration device. For example, an identifier can be a path name where a particular program is expected to be located on a demonstration device.

The content can also be a collection of different types of data, which is also referred to herein as a content module. A content module can include, for example, text or images as well as user-selectable links to programs that can be run and/or videos that can be played back. The user-selectable links are associated with identifiers of the programs and/or videos, which can in turn be run or played back in response to user selection of one of the links on a demonstration device.

When providing content to demonstration service 200, content providers can also associate particular usage types with the content. These usage types identify how particular content can be used. For example, the usage types could be background (e.g., indicating the content can be a background or wallpaper for a desktop or window), music, content module, and so forth. These different usage types can be identified by the content provider, and can be used by demonstration service 200 when demonstration experience descriptions are being configured, as discussed in more detail below.

Dashboard module 212 also allows demonstration experience descriptions to be configured by retailers, and maintains these configured demonstration experience descriptions in storage component 218, illustrated as demonstration experience descriptions 234. Configuring a demonstration experience description is also referred to as configuring a demonstration experience. Retailers can, via dashboard module 212, configure demonstration experience descriptions as they desire at virtually any time. Demonstration experience descriptions can be configured in a variety of different manners. In one or more embodiments, dashboard module 212 exposes a Web interface that can be displayed on a Web browser of configuration device 204 and that allows the retailer to select content to be included in a demonstration description. In addition, or alternatively, the retailer can identify or select, using a program running on configuration device 204, content to be included in a demonstration experience description and configuration device 204 can send or otherwise provide the demonstration experience description to dashboard module 212. As used herein, the retailer selecting or identifying content to be included in a demonstration experience description refers to a representative or agent of the retailer (e.g., an administrator or other authorized user of the retailer) selecting or identifying content to be included in a demonstration experience description.

The retailer can configure a demonstration experience for demonstration device 202 by selecting content to be included in a demonstration description for device 202. The configuration of a demonstration experience includes the definition or creation of a new demonstration experience, as well as modification of a previously created or defined demonstration experience. The retailer can select from content 222 that has been previously provided to demonstration service 200 by content providers. Dashboard module 212 can provide a variety of different interfaces to facilitate selecting content, such as displaying a list of available content with corresponding checkboxes that can be selected by the retailer to select the corresponding content, displaying a list of identifiers (names, icons, etc.) of available content that can be selected by the retailer, providing a search interface that allows content to be searched for using various keywords (e.g., that are included in descriptions of content or identifiers of content) or other characteristics of content, and so forth.

Dashboard module 212 allows the user to select from content previously provided to demonstration service 200 (optionally subject to various security constraints, as discussed in more detail below). Thus, any of the types of content that can be provided to demonstration service 200 can also be selected by a retailer. This allows the retailer to customize, for a particular demonstration experience, images for backgrounds (e.g., wallpapers) displayed, slideshows or videos displayed, programs that can be run, shortcuts or icons for programs that are displayed (e.g., on a desktop, in taskbar or dock, etc.), favorites included in a Web browser, demonstration files (e.g., image files, video files, text files) for use with programs, content modules, combinations thereof, and so forth.

In one or more embodiments, dashboard module 212 also allows a retailer to select a location for one or more types of content. Some types of content can be located in different locations for display, such as shortcuts or icons identifying programs being located in particular areas (e.g., of a desktop, taskbar or docket, etc.), content modules being displayed in particular areas (e.g., of a desktop), and so forth. For these types of content, dashboard module 212 allows a retailer to select a location for different content. The location for particular content can be selected in different manners, such as by touching or clicking on a particular location, dragging and dropping an icon on a particular location, and so forth.

Additionally, in one or more embodiments dashboard module 212 allows a retailer to select only content of a particular usage type for a particular part of the demonstration experience being configured. Dashboard module 212 allows the retailer to identify a particular part of the demonstration experience (e.g., a background, a content module to be displayed, a shortcut to a program to be displayed, and so forth). Dashboard module 212 filters the content received from content providers so that only the content appropriate to that particular part of the demonstration experience is made available to the user for selection. For example, the retailer can provide an input (e.g., selection of a menu item, touching of a portion of a screen, etc.) indicating a background image is going to be selected by the retailer, and the registration service can filter the content so as to present to the retailer only content with a usage type of background.

Furthermore, in one or more embodiments content can include a timeframe for when data can be displayed. In such embodiments, dashboard module 212 allows a retailer to select different content to be displayed in the same location but during different timeframes. For example, the retailer can select particular content including a text description and graphic image describing a particular offer and having an associated timeframe for display in a particular location. The retailer can also select particular content B including a text description and graphic image describing a different offer and having a different associated timeframe for display in that same particular location. Which of content A or content B is displayed on demonstration device 202 at a particular time depends on that particular time as well as the associated timeframes (whichever of content A or content B has an associated timeframe that includes the particular time will be the content that is displayed at that particular time).

Timeframes associated with content can be assigned in different manners and by different entities. For example, the content provider that provides the content to demonstration service 200 can specify the timeframe associated with the content. By way of another example, the retailer configuring the demonstration experience description can specify the timeframe associated with the content.

Dashboard module 212 can also optionally display a demonstration environment preview, indicating which content will be displayed in which locations for the demonstration environment. This preview can provide, for example, indications of which content will be displayed currently and which content will be displayed in the future (e.g., due to different timeframes).

Dashboard module 212 allows the retailer to configure different demonstration experiences for different groups of demonstration devices. The groups can be defined in any manner desired (and indicated) by the retailer, ranging from each individual device in a retailer environment being its own group to all devices in a retailer environment being in the same group. Dashboard module 212 allows the retailer to select groupings for devices in various manners, such as based on stock-keeping units (SKUs) assigned to different devices, based on categories of devices (e.g., gaming, professional, student, etc.), based on manufacturers of devices, based on model numbers of devices, based on components of devices (e.g., processor type or speed, graphics co-processor type or speed), form factors of devices, and so forth. Thus, for example, a retailer can configure one demonstration experience for devices that are categorized as gaming devices, and another demonstration experience for devices that are categorized as professional (e.g., targeting business usage) devices. By way of another example, a retailer can configure one demonstration experience for devices built by one manufacturer, and another demonstration experience for devices built by another manufacturer.

The information relied upon by the retailer in defining groups is provided to demonstration service 200 (e.g., via dashboard module 212) by the retailer, allowing different demonstration experiences to be selected for configuration based on this information. For example, if the retailer relies on SKUs or manufacturers of devices to define different groups, then information identifying the different SKUs or manufacturers of devices at the retailer environment associated with that retailer are provided to demonstration service 200. By way of another example, if the retailer relies on device categories (e.g., gaming, professional, student, etc.) to define different groups, then information identifying the different categories of devices at the retailer environment associated with that retailer are provided to demonstration service 200. Dashboard module 212 can thus allow the retailer to select particular information (e.g., an SKU, a manufacturer, category, etc.) to define a particular group of devices.

The content selected by a retailer for a demonstration experience is included or otherwise identified (e.g., by URI, filename, etc.) in a demonstration experience description 234 maintained in storage component 218. In one or more embodiments, for some content for a demonstration experience (e.g., data that is to be displayed or otherwise presented by a device, content modules, programs, and/or other content), an identifier of the content is included in the demonstration experience description rather than the content itself. The identified content can then be obtained by an agent module 232 from other demonstration devices or demonstration service 200 as discussed below. Alternatively, at least some content itself (e.g., data or programs of less than a threshold number of bytes, information indicating how a device is to display or otherwise present data, identifiers of where programs are located, etc.) can be included in the demonstration experience description. Additional information selected by the retailer in configuring the demonstration experience (such as locations for displaying content, timeframes, and so forth) is also included in the demonstration experience description 234. Thus, the content (or identifiers of content) and other information selected by the retailer that is used to generate the demonstration experience is stored as a demonstration experience description.

An identifier of the demonstration experience is stored as part of or otherwise associated with the demonstration experience description 234, the identifiers allowing the demonstration experience descriptions to be distinguished from one another. These identifiers can take various forms, such as personal identification numbers (PINs) provided by the retailer, a specification or listing of the criteria used to define the group of devices with which the demonstration experience is associated (e.g., the category of devices, the SKU of devices, the manufacturer of devices, etc.), and so forth. The identifier can also optionally include an identifier of the retailer that configured the demonstration experience description 234. A demonstration experience description 234 can be subsequently obtained by demonstration device 202 based on this identifier, as discussed in more detail below.

Agent interface module 214 supports communication with an agent module 232 of demonstration device 202. Content providers can provide new content and/or change content at any time, as discussed above. Similarly, retailers can define new demonstration experience descriptions and/or change demonstration experience descriptions at any time, as discussed above. Agent module 232 obtains the demonstration experience description corresponding to demonstration device 202, which is the demonstration experience description that describes the demonstration experience for device 202, thus allowing device 202 to be informed of changes to the demonstration experience description. Generally, at regular and/or irregular intervals, agent module 232 obtains changes to the demonstration experience description corresponding to device 202. Agent module 232 changes the demonstration experience on device 202 in accordance with these changes. Agent module 232 can obtain these changes in different manners.

In one or more embodiments, agent module 232 requests, from agent interface module 214, the demonstration experience description corresponding to device 202. Agent module 232 provides to agent interface module 214 an identifier of the demonstration experience description desired (e.g., a PIN, an indication of the criteria used to define the group of devices of which demonstration device 202 is a part (e.g., the category of devices, the SKU of devices, the manufacturer of devices, etc.)). Agent module 232 can request the demonstration experience description corresponding to device 202 at regular intervals (e.g., daily or weekly) and/or irregular intervals (e.g., at random or pseudo-random times, in response to retailer requests or other events, etc.). These intervals can be identified in different manners, such as being pre-configured in agent module 232, being identified by a retailer or administrator of demonstration device 202, and so forth. Agent interface module 214 can provide the demonstration experience description to agent module 232, allowing agent module 232 to identify the changes to the demonstration experience description. Alternatively, demonstration service 200 can provide an indication of the changes to the demonstration experience description since a description was last provided to agent module 232. For example, demonstration service 200 can maintain (e.g., in storage component 218) an indication of changes to the demonstration description since agent module 232 last requested the demonstration description, and provide an indication of those changes to agent module 232 in response to the request. Thus, agent module 232 can receive, from agent interface module 214, the entire demonstration experience description or alternatively a portion of the demonstration experience description.

In other embodiments, agent interface module 214 sends demonstration experience descriptions to agent module 232 on its own initiative, without receiving a request from agent module 232. In such embodiments, demonstration service 200 can maintain an indication of how to communicate with agent module 232 (e.g., a network address or other identifier of agent module 232). Demonstration service 200 can obtain this indication in different manners, such as from agent module 232 (e.g., in a previous communication), from the retailer, and so forth. Agent interface module 214 can send demonstration experience descriptions at regular intervals (e.g., daily or weekly) and/or irregular intervals (e.g., at random or pseudo-random times, in response to retailer requests (e.g., when configuring a new demonstration description) or other events, etc.). These intervals can be identified in different manners, such as being pre-configured in agent module 232, being identified by a retailer or administrator of demonstration device 202 (e.g., requested to be sent by a retailer after the retailer has modified, via dashboard module 212, the demonstration experience description corresponding to device 202), and so forth. Agent interface module 214 can send the entire demonstration experience description to agent module 232, or alternatively only a portion of the demonstration experience description (e.g., the portion that has been changed by the retailer).

In one or more embodiments, dashboard module 212 allows the retailer to save a demonstration experience description 234 as a staging description. Agent interface module 214 provides the staging description to an agent module 232 in response to a request from the agent module 232 for the staging description, but otherwise does not provide the staging description to an agent module 232. By saving the description as a staging description, a retailer is able to have a demonstration device obtain the staging description and present a demonstration experience based on the staging description as a preview. If the demonstration experience is acceptable, the retailer can save the demonstration experience description as a regular (non-staging) description, a process also referred to as publishing the demonstration experience description. Module 214 then provides the demonstration experience description to the various demonstration devices, as discussed above. Thus, the retailer is able to configure a demonstration experience description and save the description as a staging description, allowing the retailer to preview the demonstration experience based on the staging description on one device prior to the description being made available to all devices. If the preview is acceptable to the retailer, the retailer can then publish the description, making the description available to all the devices (of the corresponding group) in the retailer environment.

In one or more embodiments, communications between demonstration device 202 and agent interface module 214 are encrypted to provide secure communication. This encryption can be performed in a variety of different manners. For example, communications between device 202 and module 214 can be performed using a Secure Socket Layer (SSL) or a Transport Layer Security (TLS) protocol. By way of another example, communications can be encrypted using a public key of a public/private key pair of the receiving device or module.

Additionally, agent module 232 can request content from demonstration service 200. Situations can arise in which content to be included as part of a demonstration experience (e.g., as identified in a demonstration experience description) is not stored on device 202 (e.g., a video to be displayed, a content module to be presented, etc.), and in such situations agent module 232 can request the content from demonstration 200 (optionally after having requested the content from other demonstration devices in the same retailer environment, as discussed in more detail below). Agent interface module 214 receives such requests, and in response to a request for content module 214 sends the requested content to agent module 232. The requested content can optionally be encrypted, as discussed above.

In one or more embodiments, content is transferred from agent interface module 214 to agent module 232 in chunks or parts of a particular size (e.g., not to exceed a threshold size, such as 500 kilobytes (kB) or 1 megabyte (MB)). If content exceeds this particular size, then agent interface module 214 separates the content into smaller chunks (e.g., of approximately 500 kB or 1 MB each), and sends the content in separate chunks. Agent module 232 receives these multiple separate chunks and combines them together to re-create the content. Identifiers of chunks can be provided to agent module 232, informing agent module 232 of the order in which chunks are to be combined to re-create the content. Agent module 232 keeps a record of, or can otherwise determine, which chunks have been received and can request specific chunks from agent interface module 214. This record can be stored in nonvolatile memory, so if demonstration device 202 were to be restarted or rebooted agent module 232 can resume requesting chunks from interface module 214. Thus, if an error or problem occurs during transmission of content from agent interface module 214 to agent module 232, the chunks that were transmitted prior to the error or problem need not be re-sent to agent module 232.

Content management module 216 manages content maintained by demonstration service 200. Various different management functionality can be performed, such as compressing content, cleaning up stale content (e.g., content that has been stored in storage component 218 for at least a threshold amount of time without being included in any demonstration experience description, demonstration experience descriptions that have not been requested by an agent module for at least a threshold amount of time, content have a timeframe that has passed, etc.), and so forth.

In one or more embodiments, content management module 216 also enforces security restrictions in demonstration service 200. Various different security restrictions can be implemented by demonstration service 200 to restrict access to (as well as type of access to) content 222 and/or demonstration experience descriptions 234. These security restrictions can restrict which entities can alter (e.g., modify and/or delete) particular content 222 and/or descriptions 234, restrict which retailers can include particular content 222 in demonstration experience descriptions, and so forth. In one or more embodiments, these security restrictions restrict alteration of content 222 maintained in storage component 218 to only the content provider that provided the content to demonstration service 200. Additionally, in one or more embodiments these security restrictions restrict content to being included only in demonstration experience descriptions created by retailers that are identified by the content provider.

The security restrictions in demonstration service 200 can be implemented in a variety of different manners. In one or more embodiments, each content provider and retailer has an associated identifier (e.g., user name) and authenticates themselves to demonstration service 200 when accessing service 200. A content provider or retailer can authenticate themselves to service 200 in various manners, such as proving knowledge of a secret (e.g., a password or other identification number). Content 222 and demonstration experience descriptions 234 in storage component 218 also have corresponding access control lists, indicating which identifiers are permitted (and/or not permitted) to access the corresponding content or description and optionally what type of access is permitted. If a content provider attempts to delete or modify particular content, then in response to the attempt content management module 216 checks whether the access control list permits the deletion or modification. Module 216 allows the content to be deleted or modified only if the access control list permits the deletion or modification. Similarly, if a retailer attempts to delete or modify a particular description, then in response to the attempt content management module 216 checks whether the access control list permits the deletion or modification. Module 216 allows the description to be deleted or modified only if the access control list permits the deletion or modification.

Similarly, when content is provided to demonstration service 200, the content provider can identify one or more retailers that are permitted to access the content. If a retailer attempts to include content in a demonstration experience description, then in response to the attempt content management module 216 checks whether the access control list permits the inclusion. Module 216 restricts which content can be included in the demonstration experience description, allowing the content to be included in the demonstration experience description only if the access control list permits the inclusion. Additionally, module 216 can communicate with dashboard module 212 to indicate which content can be identified to the retailer. Thus, when a retailer is configuring a demonstration experience description, dashboard module 212 makes available only content that can be included in the demonstration experience description (based on the access control list).

Alternatively, security restrictions can be implemented in manners other than access control lists corresponding to content. For example, content provided by each content provider can be stored in storage component 218 as associated with that content provider (e.g., in a particular container file, in a particular folder, etc.). The content provider can have an associated token, and content management module 216 permits access to the content to only entities that prove they have knowledge of the token. The content provider makes the token available to each retailer that the content provider desires to have access to the content, which the retailer can in turn provide to demonstration service 200 to be able to include the content in a demonstration experience description.

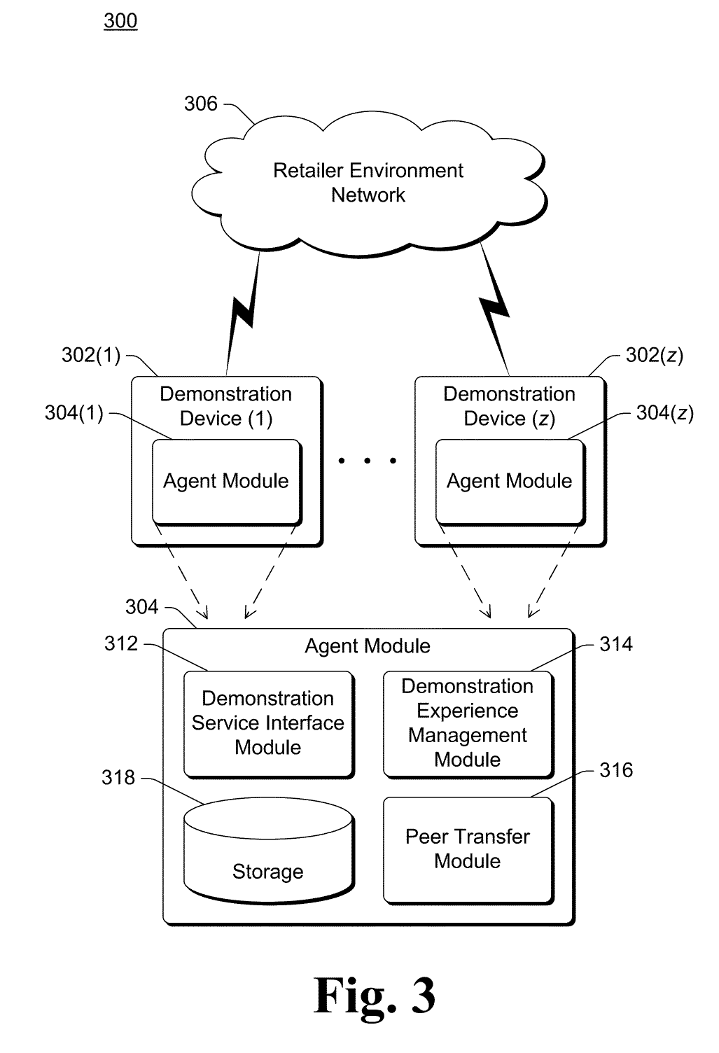

FIG. 3 illustrates an example retailer environment 300 in accordance with one or more embodiments. Retailer environment 300 can be, for example, a retailer environment 108 of FIG. 1. Retailer environment 300 includes multiple (z) demonstration devices 302, each of which can be a device 110, 112 of FIG. 1 or a demonstration device 202 of FIG. 2. Each demonstration device 302 includes an agent module 304, which can be an agent module 232 of FIG. 2.

Multiple modules are illustrated in FIG. 3, each of which can be implemented in software, firmware, hardware, or combinations thereof. Although specific modules are illustrated in FIG. 3, it should be noted that additional modules can be included in retailer environment 300. Additionally, it should be noted that the functionality of multiple modules illustrated in retailer environment 300 can be combined into a single module, and/or the functionality of one or more modules illustrated in retailer environment 300 can be separated into multiple modules.

Retailer environment 300 includes a retailer environment network 306. Retailer environment network 306 is a network created by agent modules 304, allowing devices 302 within the same retailer environment to communicate with one another. Network 306 is automatically generated by agent modules 304 in a particular retailer environment with little, if any, assistance from the retailer. Agent modules 304 can automatically identify other devices that also include an agent module 304 in various manners, such as by broadcasting a signal identifying their presence (and, for example, an agent identifier) as well as an identifier of the retailer environment (e.g., provided by the retailer). Each agent receives the signals broadcast by other agent modules, and thus can readily identify the other demonstration devices in the retailer environment. As the network is created by agent modules 304, another device in the retailer environment (e.g., a customer's device) that does not include an agent module 304 is not part of network 306.

Demonstration devices 302 can also typically (although in some instances may not, as discussed in more detail below) communicate with a demonstration service over another network (such as parts of network 106 of FIG. 1). It should be noted that the communication link from demonstration devices 302 to other networks is typically a low-bandwidth link (e.g., having less than a particular bandwidth or supporting less than a particular data transfer rate). Agent modules 304 are designed and/or configured based on awareness of the low-bandwidth nature of this link, and thus agent modules 304 attempt to avoid using this link (e.g., by obtaining content from other devices 302 rather than a demonstration service, as discussed in more detail below).

Agent module 304 includes a demonstration service interface module 312, a demonstration description management module 314, and a peer transfer module 316. Demonstration service interface module 312 manages communication with a demonstration service, such as demonstration service 200 of FIG. 2. Module 312 obtains demonstration experience descriptions (entire demonstration experience descriptions or portions of demonstration experience descriptions) from the demonstration service at regular and/or irregular intervals, as discussed above.

Demonstration experience management module 314 manages the demonstration experience on the demonstration device 302. Management module 314 manages obtaining the content identified in the demonstration experience description, and presenting the demonstration experience including the obtained content. The content identified in the demonstration experience description is stored in a storage component 318. Storage component 318 can be one or more of any of a variety of storage devices, such as one or more magnetic disks, optical disks, Flash memory, combinations thereof, and so forth.

As changes to the demonstration experience description are received, management module 314 manages obtaining any additional content identified in those changes, as well as modifying the demonstration experience in accordance with those changes. Management module 314 can determine changes to the demonstration experience description by comparing a newly obtained demonstration experience description to the previously obtained demonstration experience description, or can receive an indication of changes to the demonstration experience description from the demonstration service, as discussed above.

In one or more embodiments, if content is identified in the demonstration experience description but is not already stored in storage component 318, management module 314 communicates with peer transfer module 316 to attempt to obtain the content from another demonstration device 302 in retailer environment 300. Peer transfer module 316 sends a request for the content, via retailer environment network 306, to the other demonstration devices 302 in retailer environment 300. If another demonstration device 302 in retailer environment 300 has the requested content, that device 302 sends the requested content to peer transfer module 316. If no other demonstration device 302 in retailer environment 300 has the requested content, management module 314 communicates with demonstration service interface module 312 to obtain the requested content from the demonstration service.

Similarly, if another demonstration device 302 in retailer environment 300 requests content, peer transfer module 316 receives such requests and checks whether the requested content is stored in storage component 318 (of that device implementing the module 316). If the requested content is stored in that storage component 318, then module 316 returns the requested content to the requesting device 302. Additionally, in situations in which the requested content is obtained from the demonstration service, management module 314 also communicates with peer transfer module 316 to notify the other demonstration devices 302 in retailer environment 300 that the requested content is being obtained from the demonstration service. Thus, if another demonstration device 302 desires to obtain that requested content, that other demonstration device 302 knows that the content is already being obtained from the demonstration service by another device 302 in the retailer environment 300, and thus that another request for the content need not be sent to the demonstration service.

It should be noted that situations can arise in which the requested content is being obtained from the demonstration service by another demonstration device, but has not yet been obtained and thus is not yet available to be provided to peer transfer module 316. In such situations, management module 314 (having been notified that the other demonstration device is obtaining the content) does not obtain the content from the demonstration service, but rather waits for the content to be obtained by the other demonstration device and then peer transfer module 316 obtains the content from the other demonstration device. The other demonstration device can provide the content to peer transfer module 316 as soon as the content is obtained from the demonstration service, or alternatively peer transfer module 316 can send requests at regular or irregular intervals (e.g., every ten minutes, every hour, etc.) requesting the content from the other demonstration device.

In one or more embodiments, management module 314 implements a timeout value in waiting for the content from another demonstration device. If the requested content is not received from the other demonstration device within a threshold amount of time (the timeout value), then management module 314 proceeds with communicating with demonstration service interface module 312 to obtain the content from the demonstration service. This threshold amount of time can be a fixed amount of time (e.g., one hour, six hours, etc.) or a relative amount of time (e.g., 20% of the amount of time in an interval between agent module 304 checking for changes to the demonstration experience description).

Thus, in situations in which content identified in a demonstration experience description is not available on a particular demonstration device 302, that particular device 302 attempts to obtain the content from another device in the retailer environment 300. If no other device in the retailer environment 300 has the content, then the particular device 302 obtains the content from the demonstration service. Only one device 302 in retailer environment 300 obtains the content from the demonstration service, and that one device can then provide the content to the other devices 302 in retailer environment 300. Therefore, rather than potentially having multiple devices in the same retailer environment 300 attempt to obtain the same content from the demonstration service, and possibly clog or otherwise diminish the performance of a communication link between network 306 and the demonstration service, the communication link between network 306 and the demonstration service is only used to obtain the content by one device. After obtaining the content, that one device can then provide the content to other devices in the retailer environment 300 without again accessing the communication link between network 306 and the demonstration service.

The demonstration experience on a demonstration device 302 displays or otherwise presents various data to the user of the device 302. Different demonstration devices in retailer environment 300 can have different demonstration experiences (as defined by their demonstration experience descriptions). Various programs (as identified by the demonstration experience description) can also be made available, allowing the user to try different programs. In one or more embodiments, demonstration experience management module 314 manages the demonstration experience, allowing access to content on the device 302 identified in the demonstration experience description but not to other content. Management module 314 thus permits only particular functionality of devices 302 to be available to users of those devices, and can facilitate protecting devices 302 from malicious programs or requests. For example, module 314 can restrict which programs can be run (e.g., only the programs identified in the demonstration description), can restrict which folders or portions of a storage device can be accessed (e.g., as identified in the demonstration description), can restrict which settings can be changed, can restrict which programs and/or files can be deleted or otherwise removed, and so forth. The demonstration experience can thus be a restricted experience, with user of a demonstration device 302 being restricted to accessing data, programs, and so forth that management module 314 permits them to access. In other embodiments, module 314 displays or otherwise presents the demonstration experience, but does not otherwise restrict access to components, folders, programs, and so forth of the device 302.

Demonstration experience management module 314 can also optionally perform various other operations or functions on demonstration device 302. In one or more embodiments, module 314 performs cleanup of demonstration device 302 after a threshold amount of time (e.g., two minutes) of inactivity. This cleanup includes, for example, deleting files created since cleanup was last performed, closing files, shutting down programs, and so forth. Thus, after a user has stopped using a demonstration device 302, and the threshold amount of time elapses without user input, management module 314 cleans up the device 302 to ready the device for the next user.

In one or more embodiments, demonstration experience management module 314 also records data regarding usage of the device 302 during the demonstration experience. This usage can include identifications of which programs were run (and optionally a frequency with which they were run), which slideshows were played back (and optionally a frequency with which they were played back), which videos were played back (and optionally a frequency with which they were played back), which links were selected (and optionally a frequency with which they were selected), and so forth. This usage data can be returned to the demonstration service (e.g., demonstration service 200 of FIG. 2), or alternatively can be provided to other devices or services. This usage data allows retailers and/or content providers to analyze the usage of the device and the consumption of the content presented as part of the demonstration experience. Based on this analysis, changes can be made as desired by the content providers to provide different content and/or by the retailers to change the content included in a demonstration experience (by changing the demonstration description). As the content and demonstration descriptions can be readily modified via the demonstration service, these changes can be quickly made by content providers and/or retailers and reflected in the demonstration experiences on the demonstration devices.

In one more embodiments, recording data regarding usage of the device is performed only after receiving user consent to do so. This user consent can be an opt-in consent, where the user takes an affirmative action to request that the data be recorded. Alternatively, this user consent can be an opt-out consent, where the user takes an affirmative action to request that the data not be recorded. If the user does not choose to opt out of this data recording, then it is an implied consent by the user that the data be recorded. A privacy statement can also be displayed to the user, explaining to the user how recorded data is kept confidential. Furthermore, it should be noted that the recording of data regarding usage of the device need not, and typically does not, include any personal information identifying particular users. Thus, although data regarding usage by a particular user may be recorded, no indication of that particular user is recorded.

In one or more embodiments, the demonstration experience on a demonstration device emphasizes or describes characteristics of the demonstration device that presents the demonstration experience. For example, for a demonstration device that is a gaming device, various videos can be displayed emphasizing or describing the graphics capabilities of the demonstration device, various programs can be made available for the user to run emphasizing or illustrating the speed and audio capabilities of the demonstration device, and so forth.

In other embodiments, the demonstration experience emphasizes or describes characteristics of devices other than the demonstration device. The demonstration experience can emphasize or describe characteristics of various types of devise, such as those types discussed above with reference to devices 110, 112 of FIG. 1 as well as other types of devices (e.g., appliances, other equipment, and so forth). For example, the demonstration experience may be for a product line of digital cameras, and various videos or images can be displayed emphasizing or describing the functionality of those digital cameras and or the quality of images captured by those digital cameras. By way of another example, the demonstration experience may be for a product line of cellular phones, televisions, or appliances, and various programs can be made available that allow the user to select different cellular phones, televisions, or appliances and learn about their functionality, features, and so forth.

In the discussions herein, reference is made to demonstration devices obtaining demonstration experience descriptions and content for demonstration experiences via a network from other demonstration devices and/or a demonstration service. Alternatively, demonstration experience descriptions and/or content for demonstration experiences can be obtained by demonstration devices using other distribution mechanisms. For example, a user of configuration device 204 of FIG. 2 can obtain demonstration experience descriptions and/or content from demonstration service 200, and have the obtained demonstration experience descriptions and/or content stored on a portable storage device (e.g., a universal serial bus (USB) thumb drive or other Flash memory device) coupled to configuration device 204. A user at the retailer environment can then couple the portable storage device to various demonstration devices in the retailer environment, and have the demonstration experience descriptions and/or content transferred to the various demonstration devices. Thus, such demonstration devices can be updated with the content desired by the retailer, and at the time desired by the retailer, without accessing other demonstration devices and/or a demonstration service via a network, and even in situations in which the demonstration device has no network access.

Additionally, situations can arise in which a particular demonstration device no longer has access to the demonstration service. In such situations, the demonstration device is still able to obtain content from other demonstration devices in the retailer environment, as discussed above.

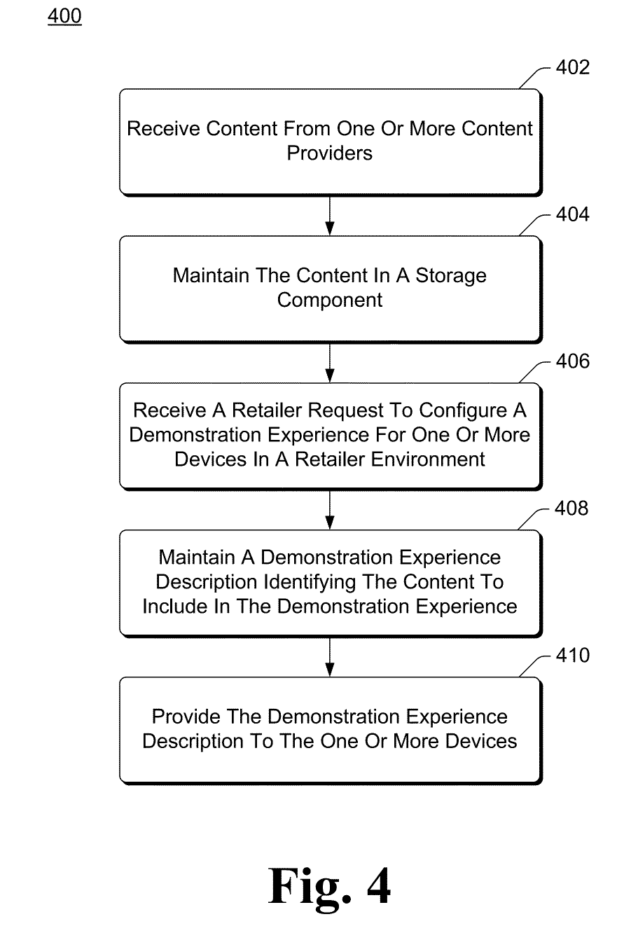

FIG. 4 is a flowchart illustrating an example process 400 for implementing service-based demonstration experience configuration in accordance with one or more embodiments. Process 400 is carried out by a service, such as demonstration service 102 of FIG. 1 or demonstration service 200 of FIG. 2, and can be implemented in software, firmware, hardware, or combinations thereof. Process 400 is shown as a set of acts and is not limited to the order shown for performing the operations of the various acts. Process 400 is an example process for implementing service-based demonstration experience configuration; additional discussions for implementing service-based demonstration experience configuration are included herein with reference to different figures.

In process 400, content from one or more content providers is received (act 402). This content can be received in different manners, such as via a Web interface exposed by the service, as discussed above.

The content received in act 402 is maintained in a storage component of the service (act 404). The storage component can be a variety of different types of storage devices, as discussed above.

A retailer request is received to configure a demonstration experience for one or more devices in a retailer environment (act 406). Multiple retailer requests can be received to configure different demonstration experiences for different groups of devices in the retailer environment, as discussed above. The configuration of a demonstration experience includes creating a new demonstration experience and/or modifying a previously created demonstration experience, as discussed above.

A demonstration experience description identifying the content to include in the demonstration experience is maintained (act 408). The demonstration experience description can be maintained in a storage component of the service, as discussed above.

The demonstration experience description is also provided to the one or more devices (act 410). The one or more devices to which the demonstration experience description is provided are the one or more devices for which the demonstration experience is configured, as discussed above.

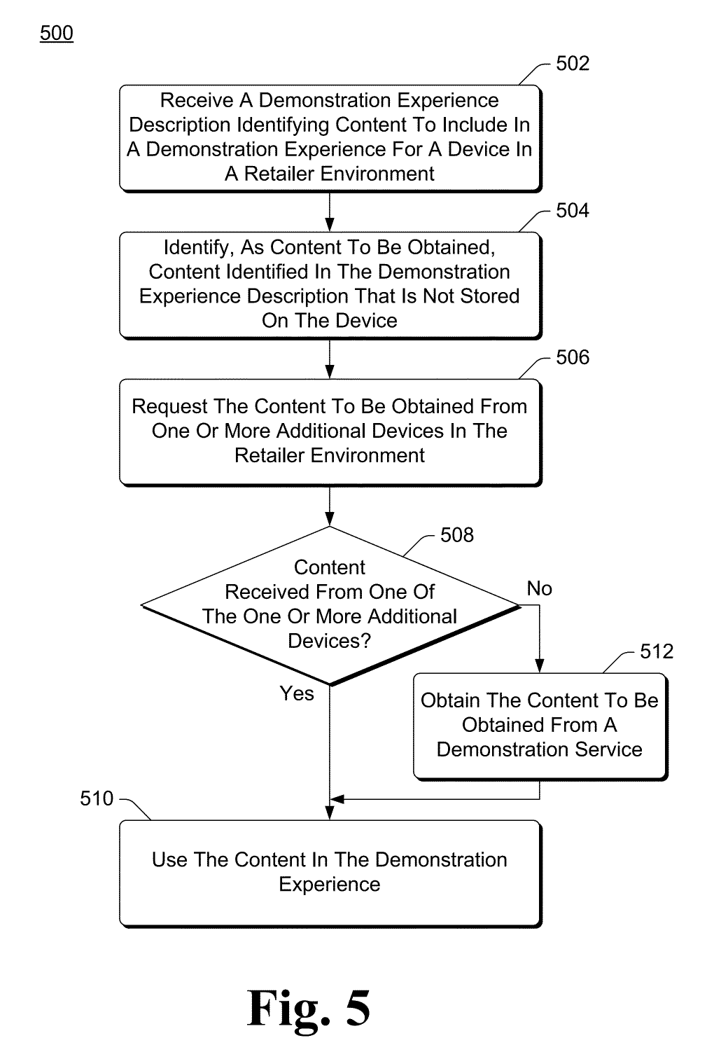

FIG. 5 is a flowchart illustrating an example process 500 for implementing bandwidth-aware obtaining of demonstration experience content in accordance with one or more embodiments. Process 500 is carried out by a device, such as a device 110 or 112 of FIG. 1, a demonstration device 202 of FIG. 2, or a demonstration device 302 of FIG. 3, and can be implemented in software, firmware, hardware, or combinations thereof. Process 500 is shown as a set of acts and is not limited to the order shown for performing the operations of the various acts. Process 500 is an example process for implementing bandwidth-aware obtaining of demonstration experience content; additional discussions for implementing bandwidth-aware obtaining of demonstration experience content are included herein with reference to different figures.

In process 500, a demonstration experience description identifying content to include in a demonstration experience for a device in a retailer environment is received (act 502). The entire demonstration experience description can be received or alternatively a portion of the demonstration experience description can be received, as discussed above.

Content to be obtained is identified as content that is identified in the demonstration experience description but is not stored on the device (act 504). This content to be obtained can be identified in different manners, as discussed above.

A request for the content to be obtained is sent to one or more additional devices in the retailer environment (act 506). This request is sent via a retailer environment network, as discussed above.

A check is made as to whether the content to be obtained is received from one of the one or more additional devices (act 508). If the content to be obtained is received from one of the one or more additional devices, then the content to be obtained is used in the demonstration experience (act 510). However, if the content to be obtained is not received from one of the one or more additional devices, then the content to be obtained is obtained from the demonstration service (act 512), and is used in the demonstration experience (act 510). In act 512, the demonstration service is external to the retailer environment, referring to the demonstration service not being part of the retailer environment (e.g., accessible to the device implementing process 500 via the Internet or another network).

Thus, the techniques discussed herein provide a dynamic, robust environment for demonstration experience configuration. Content providers can provide new and updated content to the demonstration service whenever the content providers desire, and this content can be leveraged by the retailers to configure demonstration experiences whenever the retailers desire. The techniques discussed herein provide for easy, user-friendly configuration of demonstration experiences for devices in a retailer environment, and allow retailers to easily configure different groups of devices in their environment however the retailers desire. Furthermore, the techniques discussed herein allow devices to obtain content from other devices and/or the demonstration service without the need for a centralized server or content distribution device in the retailer environment.

Various actions such as communicating, receiving, sending, recording, storing, obtaining, and so forth performed by various modules are discussed herein. A particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

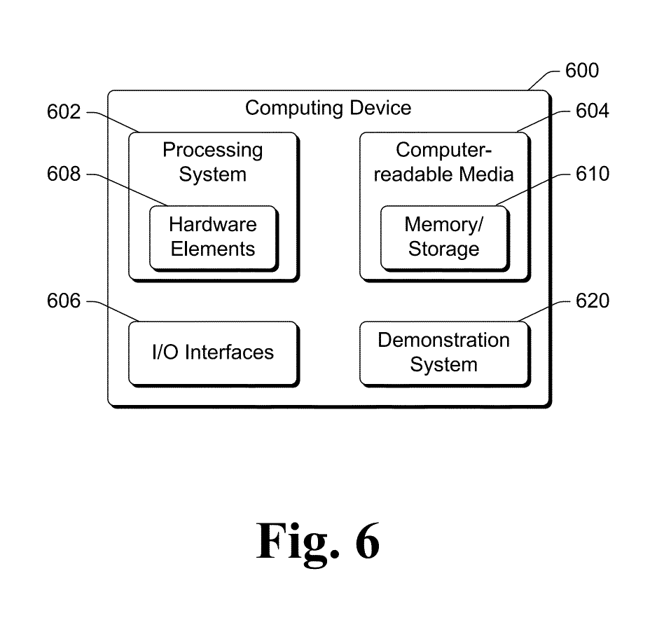

FIG. 6 illustrates an example computing device 600 that can be configured to implement the service-based demonstration experience configuration in accordance with one or more embodiments. Computing device 600 can, for example, be a device 110 or 112 of FIG. 1, implement at least part of demonstration service 102 of FIG. 1 or a content provider 104 of FIG. 1, be a device 202 or 204 of FIG. 2, implement at least part of demonstration service 200 of FIG. 2, be a device 302 of FIG. 3, and so forth.

Computing device 600 as illustrated includes a processing system 602, one or more computer-readable media 604, and one or more I/O Interfaces 606 that are communicatively coupled to one another. Although not shown, computing device 600 can further include a system bus or other data and command transfer system that couples the various components to one another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

Processing system 602 is representative of functionality to perform one or more operations using hardware. Accordingly, processing system 602 is illustrated as including hardware elements 608 that can be configured as processors, functional blocks, and so forth. This can include implementation in hardware as an application specific integrated circuit or other logic device formed using one or more semiconductors. Hardware elements 608 are not limited by the materials from which they are formed or the processing mechanisms employed therein. For example, processors can be comprised of semiconductor(s) and/or transistors (e.g., electronic integrated circuits (ICs)). In such a context, processor-executable instructions can be electronically-executable instructions.

Computer-readable media 604 is illustrated as including memory/storage 610. Memory/storage 610 represents memory/storage capacity associated with one or more computer-readable media. Memory/storage 610 can include volatile media (such as random access memory (RAM)) and/or nonvolatile media (such as read only memory (ROM), Flash memory, optical disks, magnetic disks, and so forth). Memory/storage 610 can include fixed media (e.g., RAM, ROM, a fixed hard drive, and so on) as well as removable media (e.g., Flash memory, a removable hard drive, an optical disc, and so forth). Computer-readable media 604 can be configured in a variety of other ways as further described below.

Input/output interface(s) 606 are representative of functionality to allow a user to enter commands and information to computing device 600, and also allow information to be presented to the user and/or other components or devices using various input/output devices. Examples of input devices include a keyboard, a cursor control device (e.g., a mouse), a microphone (e.g., for voice or other audible inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, a tactile-response device, and so forth. Thus, computing device 600 can be configured in a variety of ways to support user interaction.

Computing device 600 also includes a demonstration system 620. Demonstration system 620 provides various demonstration experience related functionality as discussed above. Demonstration system 620 can be, for example, one or more modules 212-216 of FIG. 2, an agent module 232 of FIG. 2, or an agent module 304 of FIG. 3.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques can be implemented on a variety of commercial computing platforms having a variety of processors.

An implementation of the described modules and techniques can be stored on or transmitted across some form of computer-readable media. The computer-readable media can include a variety of media that can be accessed by the computing device 600. By way of example, and not limitation, computer-readable media can include “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 600, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 608 and computer-readable media 604 are representative of instructions, modules, programmable device logic and/or fixed device logic implemented in a hardware form that can be employed in some embodiments to implement at least some aspects of the techniques described herein. Hardware elements 608 can include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing can also be employed to implement various techniques and modules described herein. Accordingly, software, hardware, or program modules and other program modules can be implemented as one or more instructions and/or logic embodied on some form of computer-readable storage media and/or by one or more hardware elements 608. Computing device 600 can be configured to implement particular instructions and/or functions corresponding to the software and/or hardware modules. Accordingly, implementation of a module that is executable by the computing device 600 as software can be achieved at least partially in hardware, e.g., through use of computer-readable storage media and/or hardware elements 608 of the processing system. The instructions and/or functions can be executable/operable by one or more articles of manufacture (for example, one or more computing devices 600 and/or processing systems 602) to implement techniques, modules, and examples described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a service, the method comprising:
maintaining, at the service, content from one or more content providers;
receiving, at the service, a retailer request to configure a demonstration experience for one or more devices in a retailer environment, the retailer request identifying content to include in the demonstration experience;
maintaining, at the service, a demonstration experience description identifying the content to include in the demonstration experience; and
providing, from the service, the demonstration experience description to the one or more devices.

2. A method as recited in claim 1, further comprising receiving, at the service, the content from the one or more content providers at times desired by the one or more content providers.

3. A method as recited in claim 2, the receiving content comprising receiving the content via a Web interface exposed by the service.

4. A method as recited in claim 1, the content including identifiers of where data is located on the one or more devices.

5. A method as recited in claim 4, the content including data provided to the service by one of the one or more content providers.

6. A method as recited in claim 1, the content including identifiers of programs on the one or more devices.

7. A method as recited in claim 1, the content including a timeframe indicating when associated data can be presented as part of the demonstration experience.

8. A method as recited in claim 1, the receiving the retailer request comprising receiving the retailer request via a Web interface of the service.

9. A method as recited in claim 1, the one or more devices being part of a first group of devices in the retailer environment, the method further comprising:
receiving, at the service, an additional retailer request to configure an additional demonstration experience for a second group of devices in the retailer environment, the additional retailer request identifying content to include in the additional demonstration experience;
maintaining, at the service, an additional demonstration experience description identifying the content to include in the additional demonstration experience; and
providing, from the service, the additional demonstration experience description to the devices in the second group of devices.

10. A method as recited in claim 9, further comprising receiving a retailer indication of which devices in the retailer environment are part of the first group of devices, and which devices in the retailer environment are part of the second group of devices.

11. A method as recited in claim 1, further comprising:
receiving, from the one or more content providers, identifiers of which retailers are permitted to access which content; and
restricting, based on the received identifiers, which content can be included in the demonstration experience.

12. A method as recited in claim 1, the receiving the retailer request comprising receiving the retailer request from a device other than the one or more devices.

13. One or more computer-readable storage media having stored thereon multiple instructions that, when executed by one or more processors of a service, cause the one or more processors to:
maintain, at the service, content from one or more content providers;
receive, via an interface exposed at the service, a retailer request indicating content to be included in a demonstration experience for one or more devices in a retailer environment; and
provide, from the service, a demonstration experience description identifying the indicated content to the one or more devices.

14. One or more computer-readable storage media as recited in claim 13, the interface comprising a Web interface exposed by the service.

15. One or more computer-readable storage media as recited in claim 13, the content including identifiers of where data is located on the one or more devices.

16. One or more computer-readable storage media as recited in claim 13, the content including data provided to the service by one of the one or more content providers.

17. One or more computer-readable storage media as recited in claim 13, the one or more devices being part of a first group of devices in the retailer environment, the multiple instructions further causing the one or more processors to:
receive, at the service, an additional retailer request indicating content to be included in an additional demonstration experience for a second group of devices in the retailer environment; and
provide, from the service, an additional demonstration experience description to the devices in the second group of devices.

18. One or more computer-readable storage media as recited in claim 17, the multiple instructions further causing the one or more processors to receive a retailer indication of which devices in the retailer environment are part of the first group of devices, and which devices in the retailer environment are part of the second group of devices.

19. One or more computer-readable storage media as recited in claim 13, the multiple instructions further causing the one or more processors to:
receive, from the one or more content providers, identifiers of which retailers are permitted to access which content; and
restrict, based on the received identifiers, which content can be included in the demonstration experience.

20. A method implemented in a service, the method comprising:
receiving, at the service, content from one or more content providers;
maintaining, at the service, the content;
receiving, at the service, a first retailer request to configure a first demonstration experience for a first one or more devices in a retailer environment, the first retailer request identifying content to include in the first demonstration experience;
receiving, at the service, a second retailer request to configure a second demonstration experience for a second one or more devices in the retailer environment, the second retailer request identifying content to include in the second demonstration experience;
maintaining, at the service, a first demonstration experience description identifying the content to include in the first demonstration experience, the first demonstration experience description identifying data received from the one or more content providers, data stored on the first one or more devices, and one or more programs on the first one or more devices;
providing, from the service, the first demonstration experience description to the first one or more devices;
maintaining, at the service, a second demonstration experience description identifying the content to include in the second demonstration experience, the second demonstration experience description identifying data received from the one or more content providers, data stored on the second one or more devices, and one or more programs on the second one or more devices; and
providing, from the service, the second demonstration experience description to the second one or more devices.
